(19) United States
(12) Patent Application Publication
(10) Pub. No.: US 2009/0192990 A1
(43) Pub. Date: Jul. 30, 2009

(54) Method and apparatus for realtime or near realtime video image retrieval

(75) Inventors: Yuk Lun Francis Chin, Hksar (CN); Kam Pui Chow, Hksar (CN); Hing Yip Chung, Hksar (CN); Ka Ying Lai, Hksar (CN); Fuk Sang Mak, Hksar (CN); Kwan Yee Wong, Hksar (CN); Shun Cho Yuk, Hksar (CN)

Correspondence Address: BUCHANAN, INGERSOLL & ROONEY PC, POST OFFICE BOX 1404, ALEXANDRIA, VA, 22313-1404, US

(73) Assignees: The University of Hong Kong, HKSAR (CN); Verint Systems (Asia Pacific) Ltd., HKSAR (CN)

(21) Appl. No.: 12/076,851

(22) Filed: Mar. 24, 2008

(30) Foreign Application Priority Data
Jan. 30, 2008 (HK) 08101174.8

(51) Int. Cl. G06F 7/06

(52) U.S. Cl. 707/3; 707/E17.014

(57) ABSTRACT

A distributed absorbing surveillance apparatus comprising a plurality of surveillance branches at which data of a video image frame is characterised, indexed and stored locally in real-time upon capturing means browsing and searching can be conducted locally at a relatively low computational overhead upon receipt of searching instructions from a central query processor. Such a distributed surveillance apparatus also facilitates enhanced target searching speed and efficiency.

### FIELD OF THE INVENTION

The present invention relates to method and apparatus for real-time or near real-time video image capture and retrieval. More particularly, although not limiting thereto, the present invention relates to a security surveillance apparatus comprising a plurality of security surveillance cameras deployed for remote monitoring.

### BACKGROUND OF THE INVENTION

Real-time monitoring systems are useful for surveillance applications, for example, for security surveillance at places of a wide geographical spread such as airports or terminals. In such applications, a large number of security cameras, as a form of surveillance monitors, are typically deployed at distributed locations remote from the operators. With the rapid advancement of storage technologies, massive video data can be stored relatively cheaply and video surveillance systems are typically configured to store data for seven or more days. One the other hand, the large volume of searchable data means that browsing and searching of the video data for a target image would be tedious and require extensive computational power.

The present invention seeks to overcome, or at least mitigate, shortcomings of known surveillance systems.

### SUMMARY OF THE INVENTION

According to the present invention, there is provided a surveillance apparatus comprising a plurality of surveillance branches at which data of a video image frame is characterised, indexed and stored locally in real-time upon capturing means browsing and searching can be conducted locally at a relatively low computational overhead upon receipt of searching instructions from a central query processor. Such a distributed surveillance apparatus also facilitates enhanced target searching speed and efficiency.

A distributed video retrieval system as an example of the surveillance system allows queries to be processed in a decentralized approach. Therefore, once a query has been constructed at the client side, the query will be sent to the distributed local branch devices for processing. After that, metadata including a snapshot of any matched object will be sent back to the client side, so that an operator at the client side can select and browse the video sequences containing the desired objects.

In another aspect, there is described a method of surveillance using a surveillance apparatus comprising a central query processor, a client interface and a plurality of surveillance branches which are accessible in parallel by the central query processor for searching and retrieving a target image, each said surveillance branch comprising a local video image capturing device, a local indexing device for characterising and indexing images captured by said local image capturing device to produce indexed image data, a local storage device for storing said indexed image data, and a local retrieval device for retrieving said indexed image data; the method comprising the steps of: i) processing of a video image frame captured by each one of said surveillance branches locally; ii)profiling of an object or objects present in said video image frame by extracting characteristic features of an object or objects present in a said video image frame locally; iii) Indexing of said profiled object or objects with reference to the identity of said surveillance branch; and iv) searching among said plurality of surveillance branches for profiled objects by sending searching instructions from said central query processor to said plurality of surveillance branches.

By distributing searching tasks to the various local branches, image searching can be performed locally at substantially reduced computational overheads to enhance target searching speed to enhance efficiency and ensure practicability of the system.

### BRIEF DESCRIPTION OF THE DRAWINGS

Preferred examples of the present invention will be explained by way of example and with reference to the accompanying drawings in which:

FIG. 1 is a schematic diagram showing a distributed surveillance system of the present invention,

FIG. 2 is a flow chart showing a video capturing sequence,

FIG. 3 is a flow chart showing a target image retrieval process,

FIG. 4 is a flow chart showing a query construction sequence,

FIG. 5 is a flow chart showing snapshot cropping in more detail, and

FIG. 6 is a flow chart showing a query matching flow.

### DETAILED DESCRIPTION OF EXEMPLARY EMBODIMENTS

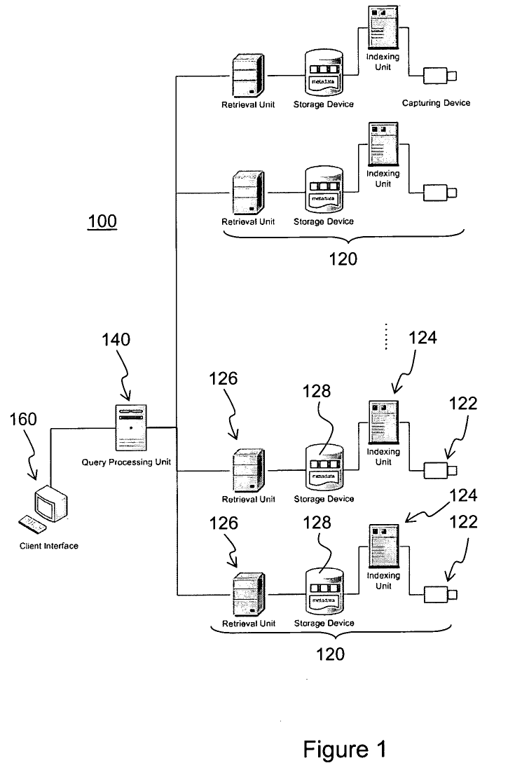

Referring to FIG. 1, a distributed video image capture and retrieval system 100 comprises a plurality of front-end video capture and retrieval units (“FVCRU”) 120 which are connected to a central query processing unit (“CQPU”) 140 for processing instructions, such as surveillance queries, originating from an operator operating a client interface unit (“160”) at the client side.

Each front-end video capture and retrieval unit 120 comprises one or a plurality of video image capturing devices 122 which are connected to an indexing unit 124. The indexing unit is connected to a retrieval unit 126 and a local storage device 128. To perform effective security surveillance, a video camera, as an example of a video image capturing device, is arranged to capture real-time video image sequence and then the images are arranged into a sequence of video image frames. In order to facilitate subsequent image retrieval with minimal time delay, the sequence of captured video image frames is fed into the indexing unit for instantaneous, or real-time, indexing so that indexed images will be available for searching forthwith. At the indexing unit 124, objects of the video sequence are firstly segmented and characterising features and/or other information of the segmented objects are indexed and then stored into the storage device in an appropriate format, for example, as searchable image databases. In this regard, it will be noted that each front-end video capture and retrieval unit is a self-functioning unit, the capturing and indexing process of each local FVCRU is performed locally and independent of the processes in other local FVCRUs.

To search for a target image, which may for example be the face or shape of a known identity or an article of known shape configuration or pattern, an operator will initiate a searching enquiry at the client interface, which is an operator station shown in FIG. 1. A searching enquiry from the client side can be presented in the form of a text description, a sample image of an object, a snapshot of a desired object appeared in a video sequence, or other appropriate searching tools from time to time known to persons skilled in the art. Upon receipt of the inquiry, the CQPU will process the inquiry and convert it into a form recognizable by the individual retrieval units, and then fire or distribute the inquiry onto each one or a selected number of the local FVCRUs. At each FVCRU, each query matching is performed by comparing the search criteria with the object data stored in the storage device of the respective FVCRUs. Matched object data are then short-listed and returned to the client side, that is, the CQPU, for further processing. Upon collecting and processing all the object data which have been returned from the local FVCRUs within a predetermined time frame, the CQPU will present the retrieval results to the user for security screening.

An exemplary application of the system of FIG. 1 is to monitor a large area, such as an airport, where hundreds of surveillance cameras may be setup at different locations. For example, when an operator has identified a suspect from a particular video sequence captured by a specific local capturing device, the operator can then select and capture a snapshot of the suspect from the video source file to construct a query. An operator can then use the query to search through all other video image sequences captured by other surveillance cameras, in order to track and locate the suspect in real-time. More detailed operation of the above will be explained below.

### Image Indexing

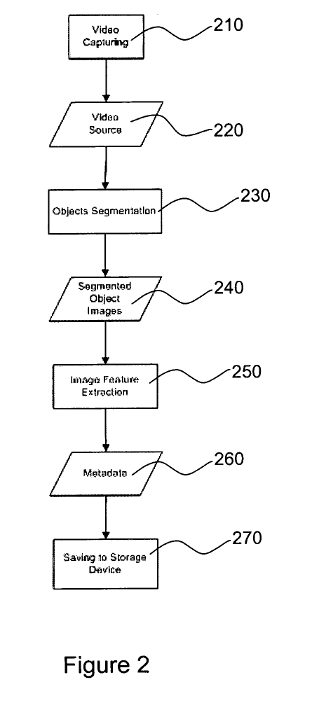

In order to formulate a searchable query, which is understandable by the local retrieval processing units 126, so that a target image can be searched at a higher speed and efficiency, a target image is first converted into metadata by an indexing process which is termed “image feature extraction” process herein. To produce the usable searchable metadata, captured video data corresponding to a target image are processed and analysed to compile a searchable data structure (more specifically metadata structure), as illustrated in the flow chart of FIG. 2. It will be appreciated that the term metadata used in this context is to describe the searchable data structure, and the construction of metadata is referred to as indexing herein.

In this example, as shown in the flow chart of FIG. 2, the indexing process involves two main initial steps, namely, object segmentation and image feature extraction. When a scene is captured by the capturing device at step 210, it will be converted into video source or video images at step 220. The video images are then fed into an object segmentation unit 230 at which moving objects will be segmented from the video sequence by, for example, a vector segmentation algorithm, to produce segmented object images at step 240. After that, the segmented object images will be analysed so that their characteristics and features (e.g. color histogram in hue color space, edge direction histogram and trajectory/motion) are extracted to construct the searchable metadata in step 260. This process will be referred to as “image feature extraction” as step 250 herein and will be discussed in more detail below. The extracted object features, together with the video information (e.g. authors, URL, recording time/place, etc), will be combined to form a piece of metadata, and will then be saved on the storage device 128 at step 270.

### Image Retrieval

In order to search for the presence of a target image in any of the FVCRUs, images stored in the individual storage devices 128 will be searched so that a target can be tracked and/or located. To facilitate such searches, an operator will need to prepare a searching description of the subject to be tracked or located. The searching description will then be converted into a metadata structure of a format compatible with the metadata structure of the stored video image files so that automated searches can be conducted by the CQPU 140 and the individual retrieval units 126. Searching descriptions will be described in more detail below.

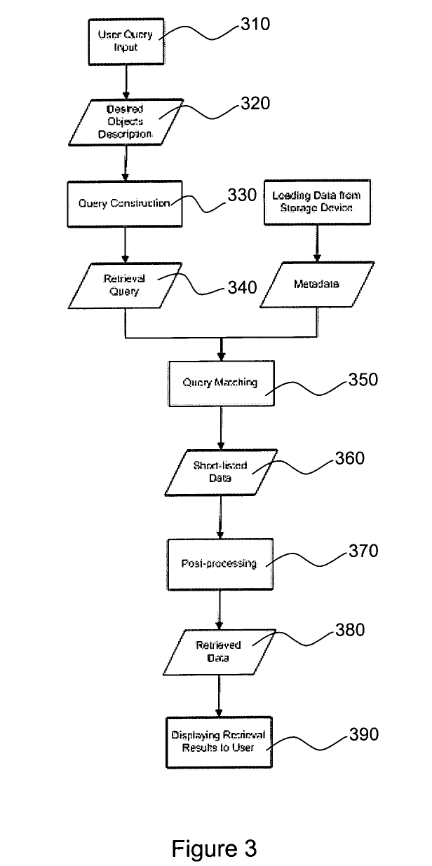

As shown in FIG. 3, to initiate a searching process at step 310, an operator will input a searching description syntax at step 320. This searching description will be converted into a retrieval query at step 340 by a query processing unit, and through a query construction step 330. After a retrieval query has been constructed, the retrieval query will be sent to the individual retrieval units 126 of the various FVCRUs for query match at step 350 for matching with metadata stored on the storage devices 128. Short-listed data at step 360 from the distributed retrieval units 126 will be collected by the CQPU 140 for post-processing at step 370. After that the overall retrieval results obtained at step 380 will be displayed to the user at step 390.

### Query Construction

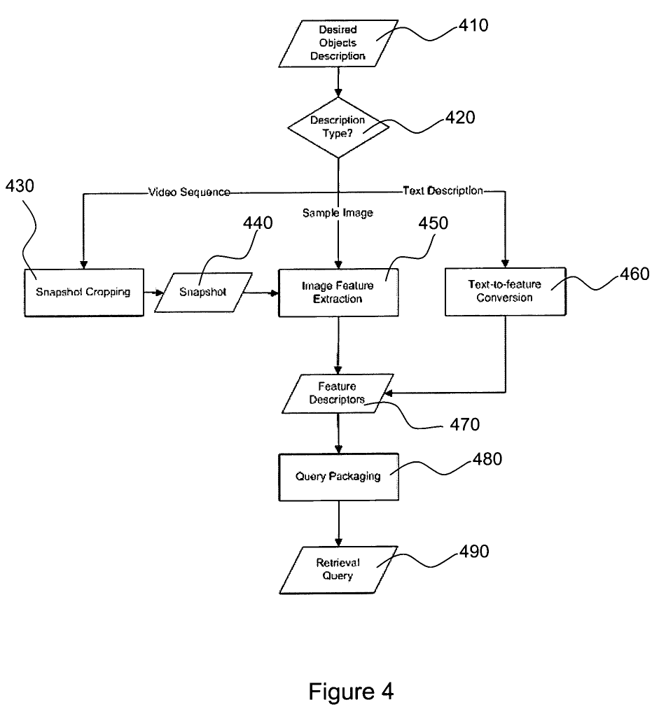

An exemplary data flow illustrating the construction of a retrieval query according to the desired object description input by a user is shown as step 410 in FIG. 4. A video sequence, a sample image, or a text description can be examples of possible desirable object description.

In the case of a sample image, the sample image is directly passed to the image feature extraction process in which characteristic features, e.g. color, motion, edge pattern, of the sample image will be extracted. Output of the feature extraction process (step) 43 will be a feature descriptor which is used to construct the retrieval query in a subsequent process.

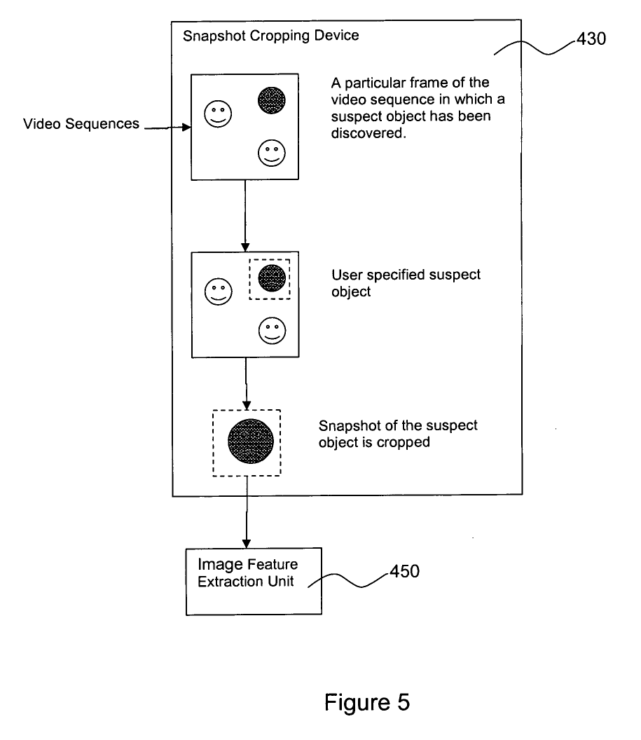

For a video sequence, a most recently captured sequence of video images will be passed onto a snapshot cropping process 430 as shown in more detail in FIG. 5, which shows the chopping of an example snapshot from a video image frame for forming a search query. Snapshot cropping is a user-interactive process in which a user can browse through the video sequence. When a suspect object appears in the video sequence, the user can select the image of a target object and to crop a snapshot of the selected object. The cropped snapshot obtained at step 440 will then be passed to the image feature extraction process 450, similar to that described in relation to the sample image above, in order to extract the features of the snapshot.

For a text description, the text description will be passed to a text-to-feature conversion process 460, in which the key words in the text description will be analysed to form a feature descriptor at step 470.

After an extracted feature descriptor has been formed, it will be packaged in the query packaging process at step 480 to form the retrieval query at step 490 which can be in any standard data manipulation format, for example, MPEG-7 (RTM) description.

### Image Feature Extraction

In order to index captured images to facilitate subsequent retrieval, each video image frame, and more particularly, each snapshot of an image, will undergo a process which is termed “feature extraction process”. Three feature extraction processes, namely, color extraction, motion extraction, and edge pattern extraction, will be explained as examples below. It should be appreciated that the extraction processes can be performed either independently, in parallel or correlated in a sequential order.

### Color Extraction

Color extraction involves the extraction and output of a color descriptor to describe the color information of the input image. In this scheme, color descriptor is implemented as dominant color description. Each pixel on the input image is determined to fall into one of the non-overlapping color regions in the RGB color space, which is evenly partitioned, depending on the color value of such pixel. The first N color regions with the largest pixel counts are considered to be the dominant color regions, and are used to construct the dominant color descriptor. The color descriptor C is then formulated as:

C={<cᵢ, pᵢ>}_{i=1 . . . N}

Where cᵢ is the mean color vector <rᵢ,gᵢ,bᵢ> of the corresponding i-th dominant color region in RGB color space, and pᵢ is the corresponding percentage of the number of pixel count in this color region. In the current implementation, N has been chosen to be 3. A more detailed description of this is described in the article [Ref 1].

### Motion Extraction

In the motion extraction scheme, the trajectory of an object will be extracted to form a motion descriptor. In addition to a still image or a snapshot, other motion information, such as motion vector or trajectory, will also be required. For the indexing process, object tracking algorithm is firstly performed in order to track a segmented object, and the corresponding trajectory will then be given by the object tracking results. For the query construction process, the current or anticipated trajectory will be specified by the user. The trajectory will then be output as a motion descriptor which is in the form of trajectory in a 2-D coordinate system as follows:

T={<xᵢ, yᵢ>}_{i=1 . . . N}

Where <xᵢ, yᵢ> is the point at x- and y-coordinates of the trajectory at time interval i, and N is the total number of time interval. The trajectory can be given either by object tracking algorithm during the indexing process or by user specified parameters during retrieval process.

### Edge Pattern Extraction

Edge pattern extraction involves the extraction of edge pattern of an image in the form of edge descriptor from the input image/snapshot. To construct an edge descriptor, the input image/snapshot is firstly divided into 4×4=16 sub-images or sub-image regions. For each sub-image, a local edge directional histogram is constructed by classifying the direction of each pixel on the sub-image into one of five directional categories, which are no-direction (no edge), 90°-direction (vertical-direction), 0°-direction (horizontal-direction), 45°-direction, and 135°-direction. There are totally 4×4=16 local edge directional histograms which correspond to 16 sub-images. These 16 sub-images are then combined for further construction of 13 semi-global edge directional histograms, and 1 global edge directional histogram.

An examplary edge descriptor is formulated as below:

E={<hᵢ^{lc}>, <hⱼ^{sg}>, <hₖ^{gl}>}_{i=1 . . . M, j=1 . . . N, k=1 . . . P}

Where M=16×5=80 is the total number of local edge directional histograms, N=13×5=65 is the total number of semi-global edge directional histograms, and P=5 is the number of global histograms. hᵢ^{lc} represents the i-th bin of local edge directional histograms, hⱼ^{sg} represents the j-th bin of semi-global edge directional histograms, and hₖ^{gl} is the k-th bin of global edge directional histograms. The extracted feature descriptors are then post-processed, and output as polished feature descriptors which consist of the color, motion, and edge pattern descriptors, as described in “Introduction to MPEG-7, Multimedia Content Description Interface” by Manjunath et al., Wiley 2002, which is incorporated herein by reference.

In addition to the above, other image feature description schemes, such as those described in the article entitled “Object-Based Surveillance Video Retrieval System With Real-Time Indexing Methodology” by Yuk et al, in Proc. International Conference on Image Analysis and Recognition (ICIAR2007), pages 626-637, Montreal, Canada, August 2007, which are incorporated herein by reference, are applicable to be used in the scheme described herein.

### Query Matching

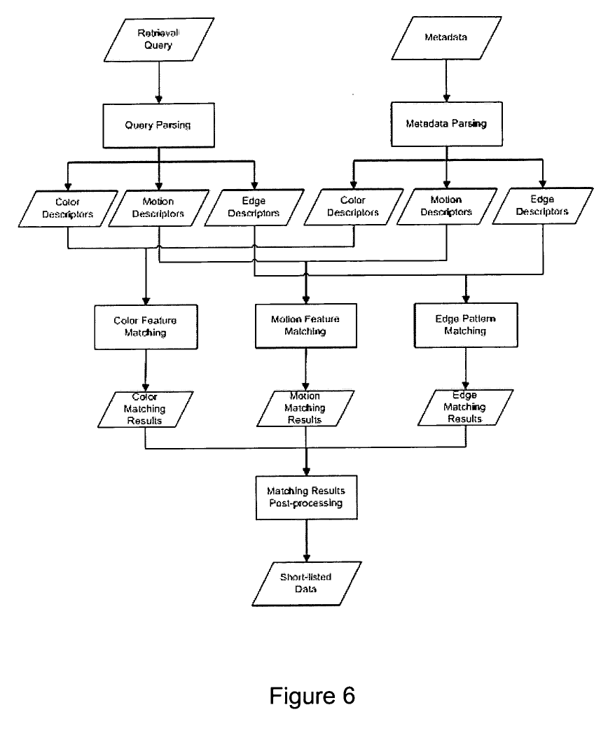

An exemplary query matching flow in which a retrieval query is matched with the metadata stored on a local storage device in order to retrieve desired object data which have been recorded in the storage device is illustrated in FIG. 6.

Referring to FIG. 6, a retrieval query is firstly parsed to extract the feature descriptors, including the color, motion, and edge descriptors. The color, motion, and edge descriptors are then matched with the corresponding descriptors, which are extracted from the metadata in a similar way, respectively. The matching results of the corresponding feature descriptors are then gathered and post-processed in order to produce the short-listed data of the matched object records.

### Color Descriptor Matching:

Two color descriptors are considered to be matched when D_{dc}<th_{dc} for some pre-defined threshold th_{dc}, and D_{dc}, refers to the distance between two color descriptors C and C′:

D_{dc}=Σ^{N}ᵢ₌₁pᵢ²+Σ^{N}ⱼ₌₁pⱼ^{,2}−Σ^{N}ᵢ₌₁Σ^{N}ⱼ₌₁2a_{i,j}pᵢpⱼ′

Where a_{i,j}=1−d_{i,j}/dₘₐₓ in which d_{i,j}=|cᵢ−cⱼ| and dₘₐₓ is the maximum allowable distance. (ref. [1])

### Motion Descriptor Matching:

In this scheme, the distance, D_{md}, between two trajectories T and T′ is measured as the start/end points difference:

D_{md}²=max{(x₁−x₁′)²+(y₁−y₁′)²,(x_{N}−x_{N}′)+(y_{N}−y_{N}′)²}

Where max{A₁, A₂, . . . , Aₙ} returns the maximum value of A₁, A₂, . . . , Aₙ.
Two motion descriptors are considered to be matched when:

D_{md}<th_{md} for some pre-defined threshold th_{md}.

### Edge Descriptor Matching:

Two edge descriptors are considered to be matched when D_{ed}<th_{ed} for some pre-defined threshold th_{ed}. D_{ed} refers to the distance between two edge descriptors E and E′, and is defined as:

D_{ed}=Σ^{M}ᵢ₌₁|hᵢ^{lc}−hᵢ^{lc}′|+Σ^{N}ⱼ₌₁51 hⱼ^{sg}−hⱼ^{sg}′|+Σ^{P}ₖ₌₁|hₖ^{gl}−hₖ^{gl}′|

In addition or as alternatives, the characterising features may be one or a combination of the following:

i) Color histogram in hue color space,

ii) Dominant colors descriptor,

iii) Hu moments shape descriptor,

iv) Edge direction histogram,

v) Trajectory,

vi) Duration

Furthermore, to facilitate more accurate object feature extraction, Gaussian Mixture Model (GMM) background modelling may be used. In such a case, only the foreground region of each segmented object needs to be processed for feature extraction. In addition or as an alternative, the extracted object features together with the video information (for example, authors, URL, recording time/place, etc) are indexed into the storage unit.

Moreover, a query can be constructed by either loading sample images or hand-drawing images of the desired objects. The features of the input images can then be extracted and used for querying video sequences that contain the desired objects. Of course, manual description of the desired objects for constructing the query may also be used.

1. A surveillance apparatus comprising a central query processor, a client interface and a plurality of surveillance branches which are accessible in parallel by the central query processor for searching and retrieving a target image, each said surveillance branch comprising a local video image capturing device, a local indexing device for characterising and indexing images captured by said local image capturing device to produce indexed image data, a local storage device for storing said indexed image data, and a local retrieval device for retrieving said indexed image data; wherein each said surveillance branch is arranged to characterise, index and store data of a video image frame locally in real-time upon capturing.

2. A surveillance apparatus according to claim 1, wherein the central query processor is arranged to distribute searching instructions to said plurality of surveillance branches, each said surveillance branch being arranged for searching and retrieving a target image or target images in real-time upon receipt of a searching command containing searching instructions and information in relation to a target image.

3. A surveillance apparatus according to claim 2, wherein the client interface is arranged to issue searching commands containing information in relation to a target image to said central query processor.

4. A surveillance apparatus according to claim 2, wherein each said surveillance branch is arranged to return data and information in relation to identified target images in real-time to said central query processor upon identification of said target images.

5. A surveillance apparatus according to claim 1, wherein said plurality of surveillance branches is distributed at different geographical locations for remotely monitoring motion or activities at different geographical locations.

6. A surveillance apparatus according to claim 1, wherein the local indexing device is arranged to index an image of an object or images of objects appearing on a said video image frame with reference to characteristic features of said object or said objects.

7. A surveillance apparatus according to claim 6, wherein said central query processor is arranged such that a locally stored image frame stored at any one of said plurality of surveillance branches is extractable remotely by an operator at said client interface, said image frame being editable to form a searchable target image.

8. A surveillance apparatus according to claim 7, wherein said central query processor is arranged to distribute characteristic information of a said searchable target image to said plurality of surveillance branches for target image searching.

9. A surveillance apparatus according to claim 8, wherein said characteristic information includes information on colour, pattern, shape, configuration, outline, motion, or any combination thereof.

10. A surveillance apparatus according to claim 8, wherein said characteristic information is in metadata structure.

11. A surveillance apparatus according to claim 2, wherein said plurality of surveillance branches is arranged such that upon receipt of characteristic information for target image searching, the local retrieval device of each said surveillance branch operates to search images matching said characteristic information and to return data and/or information in relation to the matched images to said central query processor.

12. A method of surveillance using a surveillance apparatus comprising a central query processor, a client interface and a plurality of surveillance branches which are accessible in parallel by the central query processor for searching and retrieving a target image, each said surveillance branch comprising a local video image capturing device, a local indexing device for characterising and indexing images captured by said local image capturing device to produce indexed image data, a local storage device for storing said indexed image data, and a local retrieval device for retrieving said indexed image data; the method comprising the steps of:
processing of a video image frame captured by each one of said surveillance branches locally;
profiling of an object or objects present in said video image frame by extracting characteristic features of an object or objects present in a said video image frame locally;
Indexing of said profiled object or objects with reference to the identity of said surveillance branch; and
searching among said plurality of surveillance branches for profiled objects by sending searching instructions from said central query processor to said plurality of surveillance branches.

13. A method of surveillance according to claim 12, wherein the steps of processing, profiling and indexing are performed in real time upon image capturing.

14. A method of surveillance according to claim 12, wherein the method comprising the step of sending data relating to an image or images identified from said surveillance branches to said central query processor.
